(19) United States
(12) Patent Application Publication
(10) Pub. No.: US 2023/0104586 A1
(43) Pub. Date: Apr. 6, 2023

(54) HYDROGEN MIXING SYSTEM

(71) Applicant: BECKETT THERMAL SOLUTIONS, North Ridgeville, OH (US)

(72) Inventors: JACOB CLEARY, Parma, OH (US); Dave Killer, Derbyshire (GB); Tony Bailey, Derbyshire (GB); Matthew Bower, Derbyshire (GB)

(21) Appl. No.: 17/955,729

(22) Filed: Sep. 29, 2022

Related U.S. Application Data
(60) Provisional application No. 63/252,858, filed on Oct. 6, 2021.

(51) Int. Cl. B01F 25/441; B01F 25/46; B01F 23/10

(52) U.S. Cl. CPC B01F 25/4413; B01F 25/46; B01F 23/191; B01F 2025/9121

(57) ABSTRACT

A system for mixing hydrogen gas and air includes a housing extending from a first end to a second end and defining a mixing chamber. The second end receives the air. A tubular mixer in the mixing chamber extends along a central axis from a first end to a second end. The mixer has an outer surface and an inner surface defining a central passage. The second end is closed by an end wall. The mixer has first fluid directing structure for directing the air and the hydrogen gas radially inward from the mixing chamber to the central passage to form a mixture. A distributor is secured to the first end of the housing and receives the mixture from the first end of the mixer. The distributor includes second fluid directing structure for directing the mixture radially outward to a burner.

### RELATED APPLICATIONS

This application claims the benefit of U.S. Provisional Application Ser. No. 63/252,858, filed Oct. 6, 2021, the entirety of which is incorporated by reference herein.

### TECHNICAL FIELD

The present invention relates generally to fuel burning systems, and specifically to a mixing system for a hydrogen combustor.

### BACKGROUND

Hydrogen gas is an extremely volatile and easy to ignite gaseous fuel. Over time, it has become apparent that the traditional manner of mixing gas and air in the blower motor using hydrogen is undesirable as a flashback condition may occur. With this in mind, it has become more tenable to operate a hydrogen burner by providing the fuel/air mixer downstream of the blower motor and upstream of the burner surface.

### SUMMARY

In one example, a system for mixing hydrogen gas and air includes a housing extending from a first end to a second end and defining a mixing chamber. The second end receives the air. A tubular mixer is provided in the mixing chamber and extends along a central axis from a first end to a second end. The mixer has an outer surface and an inner surface defining a central passage. The second end is closed by an end wall in a fluid-tight manner. The mixer has first fluid directing structure for directing the air and the hydrogen gas radially inward from the mixing chamber to the central passage to form a mixture of hydrogen gas and air. A distributor is secured to the first end of the housing and receives the mixture of hydrogen gas and air from the first end of the mixer. The distributor includes second fluid directing structure for directing the mixture radially outward to a burner to be ignited.

In another example, a device for mixing hydrogen gas and air includes a tube extending along a central axis from a first end to a second end. The tube has an outer surface and an inner surface defining a central passage. The second end is closed by an end wall in a fluid-tight manner. Fluid directing structure is provided around the tube for directing the air and the hydrogen gas radially inward from outside the tube to the central passage to form a mixture of hydrogen gas and air that rotates radially about the central axis along the interior of the tube.

Other objects and advantages and a fuller understanding of the invention will be had from the following detailed description and the accompanying drawings.

### BRIEF DESCRIPTION OF THE DRAWINGS

FIG. 1 is a schematic illustration of an example mixing system for a hydrogen burner.

FIG. 2 is a section view taken along line 2-2 of FIG. 1.

FIG. 3 is a schematic illustration of a mixer of the mixing system of FIG. 1.

FIG. 4A is a top view of a distributor of the mixing system of FIG. 1.

FIG. 4B is a bottom view of the distributor.

FIG. 5 is a schematic illustration of the mixing system in use.

### DETAILED DESCRIPTION

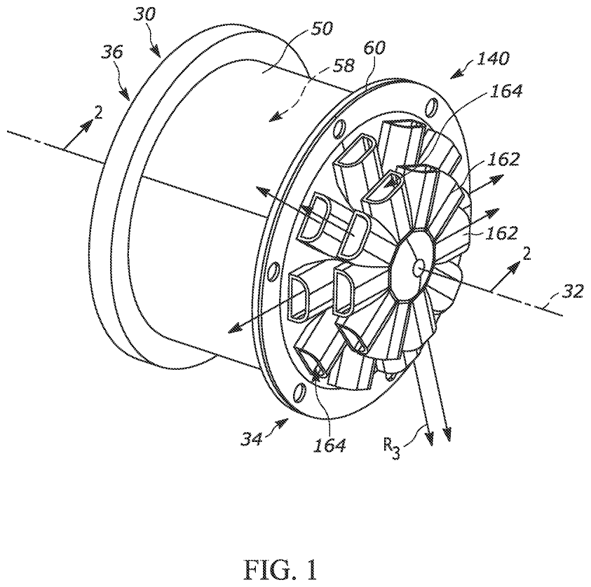

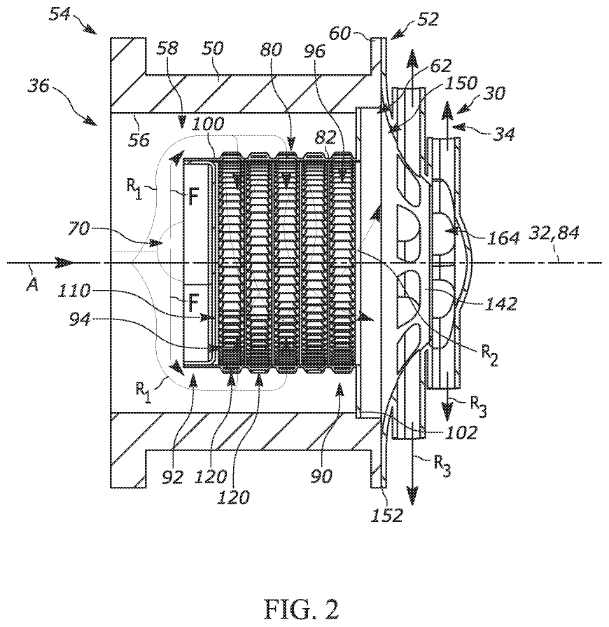

The present invention relates generally to fuel burning systems, and specifically to a mixing system for a hydrogen combustor. FIGS. 1-2 illustrate an example mixing system 30 in accordance with the present invention. The mixing system 30 can be used in industrial, household, and commercial heating appliances such as, for example, a water heater, boiler, furnace, etc. More specifically, the mixing system 30 shown and described herein can be used in a hydrogen boiler, hydrogen instantaneous water heater or any gas system configured to operate with a pre-mixed burner and run on 100% or substantially 100% hydrogen.

The mixing system 30 extends along a centerline 32 from a first end 34 to a second end 36. In the example shown, the first end 34 forms a downstream end and the second end 36 forms an upstream end. The mixing system 30 includes a housing 50 extending from a first end 52 to a second end 54. The housing 50 has an inner surface 56 defining a passage or mixing chamber 58. The passage 58 extends the entire length of the housing 50 and receives air A at the second end 54 of the housing 50.

A flange 60 extends radially outward from the first end 52 of the housing 50. A counterbore 62 extends into the first end 52 of the housing 50 towards the second end 54 and is coextensive with the passage 58. At least one opening 70 extends radially through the housing 50 to the mixing chamber 58. In one example, each opening 70 can form a gas inlet opening for receiving fuel, e.g., hydrogen gas.

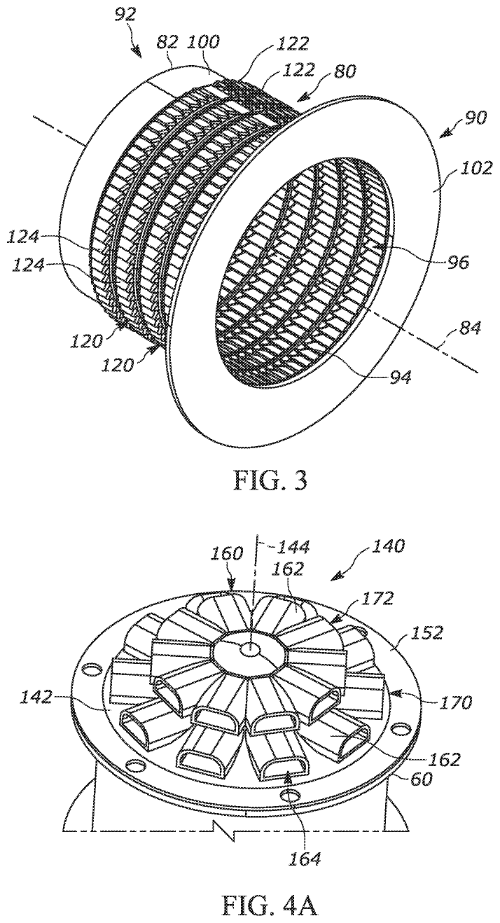

The mixing system 30 further includes a mixer or mixing device 80 for producing a swirling, spiraling and/or rotating mixture of air and fuel within its interior. Referring to FIG. 3, the mixer 80 includes a tube 82 extending along a central axis 84 from a first, downstream end 90 to a second, upstream end 92. The tube 82 includes an inner surface 94 defining an interior or central passage 96 and an outer surface 100.

The first end 90 of the tube 82 includes a radially extending flange 102. A wall 110 (see FIG. 2) is secured to the second end 92 of the tube 82 to seal the upstream end of the central passage 96 in a fluid-tight manner. The periphery of the tube 82 includes fluid directing structure 120 for directing fluid radially inward from outside the tube to the central passage 96 to thereby homogenously mix air and fuel therein.

In one example, the fluid directing structure 120 includes a series of openings 122 arranged in rows encircling the axis 84 to form endless loops about the axis. The rows are arranged along the length of the tube 82. A fin or guide 124 is associated with each opening 122. The guides 124 within each row can face the same direction (as shown) or different directions (not shown). The guides 124 in different rows can face the same direction or different directions.

Alternatively, the fluid directing structure 120 can constitute any of the fluid directing structure configurations shown and described in U.S. Pat. No. 9,528,698 (issued Dec. 27, 2016), the entirety of which is incorporated by reference herein. As shown, all the guides 124 are configured to direct fluid circumferentially about the axis 84 in a rotating or swirling manner, although rotating or swirling is not required so long as the fluid flowing through the fluid directing structure 120 is homogenously mixed.

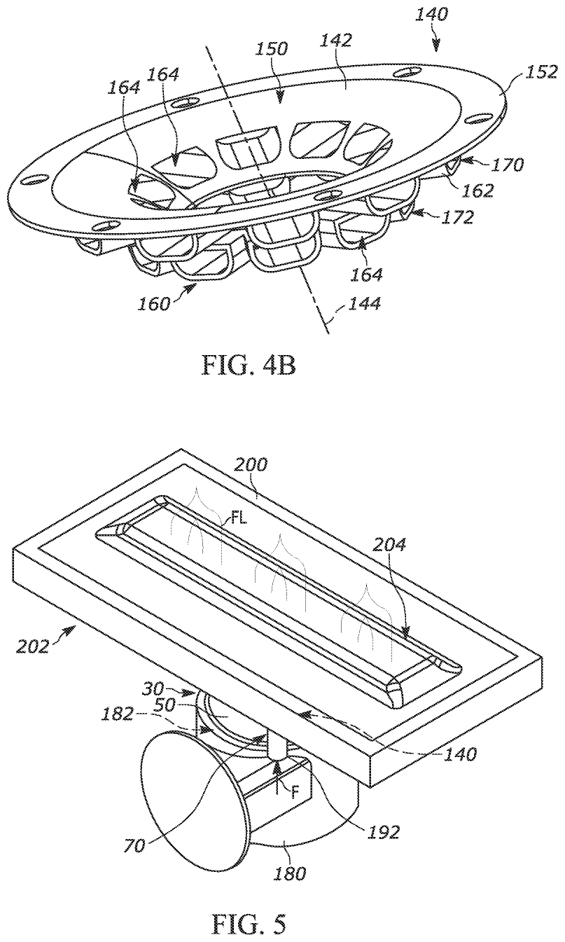

The mixing system 30 further includes a distributor 140 (FIGS. 4A-4B). The distributor 140 includes a hollow base 142 having a centerline 144. In one example, the base 142 is domed. In any case, the base 142 defines a cavity 150. A flange 152 extends radially outward from the base 142. Fluid directing structure 160 is provided on the base 142, e.g., on the exterior thereof. In one example, the fluid directing structure 160 includes a series of hollow projections 162 that each have a passage 164 in fluid communication with the cavity 150 and extend the entire length of the projection. Consequently, the passages 164 fluidly connect the cavity 150 to the exterior of the distributor 140. The passages 164 can have longitudinal cross-sections that are hemispherical, round, triangular, polygonal etc.

As shown, the projections 162 extend radially outward from the centerline 144 and are symmetrically arranged about the centerline 144. The longitudinal trajectory of each projection 162 can intersect the centerline 144 or be spaced/offset therefrom. That said, the projections 162 can also extend in directions that include axial and/or circumferential components relative to the centerline 144 (not shown). It will be appreciated that the projections 162 can be arranged in multiple rows 170, 172 (as shown) or a single row. When multiple rows 170, 172 are provided, the rows can be stacked atop one another in a direction along the centerline 144.

The projections 162 in each row can have the same length in the radial direction or different lengths. Moreover, the projections 162 of one row can have the same length as the projections in any other row or have different lengths. In the example shown, the projections 162 in the row closest to the base 142 are longer than the projections in the adjacent row further from the base.

The projections 162 in each row can be circumferentially aligned with the projections of adjacent row(s) (as shown) or circumferentially offset from the projections in adjacent row(s) (not shown). It will be appreciated that the projections 162 can also be asymmetrically arranged about the centerline 144 in the first row 170 and/or in the second row 172.

When the mixing system 30 is assembled (FIG. 2), the mixer 80 is positioned in the mixing chamber 58 such that the flange 102 is located in the counterbore 62 and abuts the housing 50. The second end 92 of the mixer 80 is positioned closer to the second end 54 of the housing 50. The gas inlet opening 70 is positioned upstream of the mixer 80. The flange 102 is secured to the housing 50 in a fluid-tight manner via fasteners, weld, etc., to prevent fluid from flowing within the mixing chamber 58 and along the outside of the mixer 80 to exit the housing 50 radially outward from the tube 82.

The flange 152 on the distributor 140 abuts the flange 60 on the housing 50 to fluidly connect the central passage 96 with the cavity 150. The flanges 60, 152 are secured to one another via fasteners, weld, etc. in a manner the fluidly seals the distributor 140 to the housing 50. In other words, the only fluid path from the mixing chamber 58 to the exterior of the distributor 140 is radially inward through the fluid directing structure 120, into the central passage 96, into the cavity 150, and out through the passages 164 in the projections 162.

Referring further to FIG. 5, in one example the mixing system 30 can be positioned between a blower 180 and a burner/burner head 200. More specifically, the mixing system 30 is positioned downstream of an output/discharge 182 of the blower 180 such that the mixing chamber 58 is in fluid communication with the discharge and therefore capable of receiving air A therefrom (see also FIG. 2). To this end, the discharge 182 and mixing cavity 58 can be directly or indirectly connected to one another.

In any case, the blower 180 supplies the air A from the blower 180 to the mixing system 30. At the same time, a fuel source (not shown) supplies fuel (indicated generally at F)—in this case hydrogen gas—to a fuel pipe or fuel line 192 that extends into or is otherwise fluidly connected to the opening 70 in the housing 50. Consequently, the mixing chamber 58 receives both air A (from the blower 180) and hydrogen gas F (from the fuel source 190).

As shown in FIG. 2, as the air A flows into the mixing cavity 58, it is prevented from entering the second end 92 of the tube 82 due to the end wall 110. That said, the air A flows in the manner R₁ radially outward from the centerlines 32, 84 and to the annular/radial space between the inner surface 56 of the housing 50 and the outer surface 100 of the tube 80. As the air A flows in the manner R₁, it entrains and mixes with the incoming fuel F. In other words, the air A and fuel F begin mixing with one another as they both flow in the manner R₁ into the space between the housing 50 and the tube 80.

As noted, the flange 102 prevents fluid flow downstream of the tube 80 from outside the tube. That said, the mixing air A and fuel F flows radially inward from the mixing space 58, through the fluid directing structure 120, and into the central passage 96. The fluid directing structure 120 is configured to direct fluid radially inward from outside the tube 82 to the central passage 96 in a manner that causes the fluid to mix, e.g., by rotating and/or swirling around the axis 84 in the manner indicated generally at R₂. This turbulent action induces additional mixing of the air A and fuel F into a substantially homogenous or homogenous mixture. The now turbulent mixture flows downstream through the tube 82 (and around/about the axis 84) and into the cavity 150 of the distributor 140.

In one example, the downstream side of the distributor 140 is fluidly connected to an inlet 202 of the burner 200. The connection can be direct or indirect. In any case, the mixture of air A and fuel F flows through the cavity 150 and out of the distributor 140 through the passages 164 in the manner indicated generally at R₃. More specifically, the distributor 140 is configured to direct fluid from the cavity 150 and radially outward in directions extending away from the centerline 144 in the directions indicated generally at R₃ (see also FIG. 1).

The mixture flows out of the passages 164 and into the burner head 200, where it is ignited by an igniter (not shown) and exits an outlet(s) 204 of the burner as one or more flames FL. Although the mixing system shown and described herein includes the housing, mixer, and distributor, it will be appreciated that the mixing system can alternatively be configured to omit the housing and/or the distributor.

The mixing system shown and described herein is advantageous in that it produces a homogenous air-hydrogen gas mixture downstream of the blower, which helps to mitigate the aforementioned flashback issues. Furthermore, providing a homogenous mixture downstream of the burner also allows the mixing system to help deliver a uniform or substantially uniform flow of the mixture to the burner surface, thereby improving performance.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

1. A system for mixing hydrogen gas and air comprising:
a housing extending from a first end to a second end and defining a mixing chamber, the second end receiving the air;
a tubular mixer provided in the mixing chamber and extending along a central axis from a first end to a second end, the mixer having an outer surface and an inner surface defining a central passage, the second end being closed by an end wall in a fluid-tight manner, the mixer having first fluid directing structure for directing the air and the hydrogen gas radially inward from the mixing chamber to the central passage to form a mixture of hydrogen gas and air; and
a distributor secured to the first end of the housing and receiving the mixture of hydrogen gas and air from the first end of the mixer, the distributor including second fluid directing structure for directing the mixture radially outward to a burner to be ignited.

2. The mixing system of claim 1, wherein the first fluid directing structure includes a plurality of openings and a guide associated with each opening, the guides being angled relative to the outer surface for radially rotating the pre-mixed mixture about the central axis.

3. The mixing system of claim 2, wherein the guides are arranged in a series of rows that extend continuously around the periphery of the tube to encircle the central axis.

4. The mixing system of claim 1, wherein the second fluid directing structure comprises projections extending radially outward from a centerline of the distributor, each projection including a passage in fluid communication with the central passage of the mixer.

5. The mixing system of claim 4, wherein the projections are arranged in rows stacked atop one another along the centerline.

6. The mixing system of claim 5, wherein the projections in each row are circumferentially aligned with one another.

7. The mixing system of claim 4, wherein each projection is tubular and has a hemispherical cross-section along its length.

8. An appliance comprising:
the mixing system recited in claim 1;
a blower including an outlet for supplying air to the mixing system;
a hydrogen fuel source for supplying hydrogen gas to the mixing system; and
a burner downstream of the mixing system for receiving a mixture of the hydrogen gas and the air from the mixing system.

9. The mixing system of claim 1, wherein the mixture rotates radially about the central axis along the interior of the tube.

10. The mixing system of claim 1 further comprising at least one opening extending radially through the housing for receiving the hydrogen gas.

11. The mixing system of claim 10, wherein the at least one opening is positioned upstream of the tubular mixer.

12. A device for mixing hydrogen gas and air comprising:
a tube extending along a central axis from a first end to a second end, the tube having an outer surface and an inner surface defining a central passage, the second end being closed by an end wall in a fluid-tight manner, fluid directing structure extending around the tube for directing the air and the hydrogen gas radially inward from outside the tube to the central passage to form a mixture of hydrogen gas and air that rotates radially about the central axis along the interior of the tube.
